(19) United States
(12) Patent Application Publication
(10) Pub. No.: US 2003/0121222 A1
(43) Pub. Date: Jul. 3, 2003

(54) Window frame fastening means

(76) Inventor: Richard A. Janney, Sykesville, MD (US)

Correspondence Address: Joseph M. Gusmano, Weinstock, Friedman & Friedman, P.A., 4 Reservoir Circle, Baltimore, MD, 21208, US

(21) Appl. No.: 10/229,754

(22) Filed: Aug. 28, 2002

Related U.S. Application Data
(60) Provisional application No. 60/315,175, filed on Aug. 28, 2001.

(51) Int. Cl. E06B 3/26; E06B 3/988; E06B 3/00

(52) U.S. Cl. 52/202; 52/208; 52/204.7; 52/586.1

(57) ABSTRACT

A frame apparatus for a storm window, screen window, or like application which securely engages the existing window frame or other structure in which it is disposed without alteration of that frame or structure, and removed without damage. A minimum of tools and techniques are necessary to install or remove the frame, which will be amenable to use in frames or structures in a wide variety of sizes and shapes.

### CROSS REFERENCE TO RELATED APPLICATIONS

This application is from provisional application Ser. No. 60/315,175 filed on Jun. 28, 2001, incorporated herein by reference.

### BACKGROUND OF THE INVENTION

1. Field of the Invention

The present invention relates to window frames, and in particular, to an apparatus and method for securely fastening of a storm or screen window disposed within a window frame without the necessity of altering the existing window frame, and without the necessity of complicated hardware and manufacturing.

2. Description of the Background

For the last few decades interest has increased in the restoration and preservation of older and historic structures, and the reproduction of historic structures in a modern form. At the same time, concern has increased about the energy efficiency of structures because of the cost of energy and the impact of energy use on the human environment. Older and historic structures were built prior to the development or widespread use of modem, efficient heating sources, air conditioning, and energy saving devices such as fiberglass insulation or polymer vapor barriers.

The prior art is replete with references to methods and apparatus for increasing the energy efficiency of windows. This is largely because windows are well known to be a major source of heat transfer and air leakage from structures. This is particularly true of older and historic structures, because the windows in such structures were manufactured prior to the development of modern, efficient windows.

A long standing solution to the problem of inefficient and leaky windows of older manufacture employed in older and historic structures is the storm window. A frame is permanently affixed to the existing frame of the subject window, either outside facing the weather to protect the existing window or inside the existing window so that the view of the existing window from the outside or inside is not blocked, into which frame a removable window is disposed. In most applications, installation of the storm window on the interior is preferable because it leaves the complete view of the exterior unaltered visually. A storm window frame is affixed to an existing window frame by conventional means such as screws, nails, clips, glue, or caulk. The windows are removable for cleaning or when not needed, and a screen may be disposed in the storm window frame instead of a window to admit air. The storm window reduces air leakage and creates a pocket of air that helps to insulate the structure. The storm window may also incorporate ultraviolet light protection.

As stated above, while typical storm windows are amenable to removal, the storm window frames are not. Also, storm window frames require some modification of the window frame supported by them, such as holes drilled in the frame to accept screws. This is undesirable in several contexts. By way of one example, it requires some level of facility for the necessary tools to install such a window. By way of another example, window frames in older structures may be damaged by the application of storm window frames. By way of a further example, restrictive covenants, homeowner associations, or historic district designations in some communities prohibit the permanent installation of storm or screen windows.

In the field of historic preservation, there is a particular interest in preserving historic structures in precisely the form and condition they were built. By way of example, the U.S. Secretary of the Interior's Standards for Historic Preservation contains ten basic requirements that dictate this issue for structures qualifying for status on their National Register. The original aesthetic appeal of such structures is one reason; another is simply that the structure itself serves as an archive for methods, apparatus, and materials of the day in which it was built. Permanently attaching a storm window frame to the windows of a historic structure would severely compromise these goals in this context.

Further, in the field of historic preservation there is great interest, when maintaining and repairing historic structures, in using the materials, methods, and apparatus of the day in which it was built. Existing storm window designs are not amenable to manufacture or installation using historic tools and techniques.

In light of the above, there is a compelling need to provide a method and apparatus that will successfully address the above concerns, particularly in their application to older and historic structures. A frame apparatus for a storm window, screen window, or like application will securely engage the existing window frame or other structure in which it is disposed without alteration of that frame or structure, and removed without damage. A minimum of tools and techniques will be necessary to install or remove the frame, which will be amenable to use in frames or structures in a wide variety of sizes and shapes.

### SUMMARY OF THE INVENTION

In light of the preceding background, it is a primary object of the present invention to provide an apparatus which engages the existing window frame in an older or historic structure without alteration of or damage to said existing window frame.

It is another primary object of the present invention to provide a storm or screen window frame comprising one or more of the above described apparatus which when engaged to the existing window frame of an older or historic structure will hold said storm or screen window frame in place despite the effects of wind and weather, without alteration of or damage to said existing window frame.

It is a further object of the present invention to provide an apparatus which engages the existing window frame in an older or historic structure without alteration of or damage to said existing window frame, which further can be manufactured using tools, techniques, and hardware in existence when said older or historic structures were built.

It is a further object of the present invention to provide a storm or screen window frame comprising one or more of the above apparatus which engages the existing window frame in an older or historic structure without alteration of or damage to said existing window frame, which further can be manufactured using tools, techniques, and hardware in existence when said older or historic structures were built.

In light of the above objects, a novel apparatus of the present invention is fitted substantially within one or more members of a frame. One or more extending hardware such as set screws apply force to a first opposing surface of a spline, movably disposed within said member. A second opposing surface of said spline engages the existing window frame of a structure with sufficient force to secure the frame. A tool engages the extending hardware through a small aperture in the frame member. A novel frame of the present invention comprises one or more apparatus disposed within each of one or more of the frame members.

### BRIEF DESCRIPTION OF THE DRAWINGS

These and other objects, features, and advantages of the present invention will become more apparent from the following detailed description of the preferred embodiments and certain modifications thereof when taken together with the accompanying drawings in which:

FIG. 1 is a oblique view of an exemplary frame 20 in a preferred embodiment of the present invention.

FIG. 2 is a cross section of frame member 22 of the frame 20 of FIG. 1, showing spline 30 in a retracted position.

FIG. 3 is a cross section of frame member 22 of the frame 20 of FIG. 1, showing spline 30 in an engaged position.

FIG. 4 is a plan view cross section of frame member 22 of the frame 20 of FIG. 1.

FIG. 5 is a plan view cross section of frame member 2.22 of a frame 2.20, according to another embodiment of the present invention.

FIG. 6 is a cross section of three other exemplary embodiments of the present invention.

### DETAILED DESCRIPTION OF THE PREFERRED EMBODIMENTS

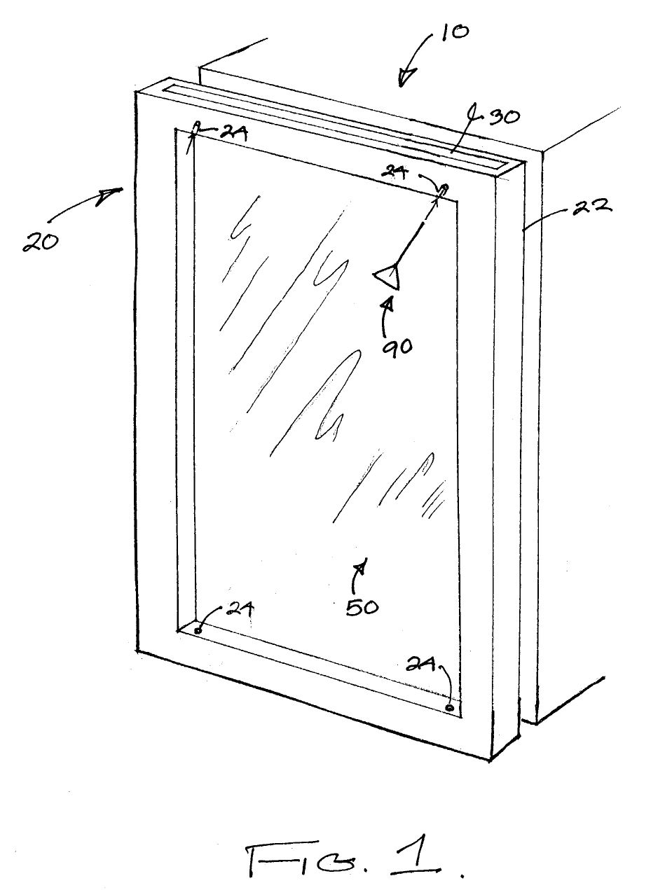

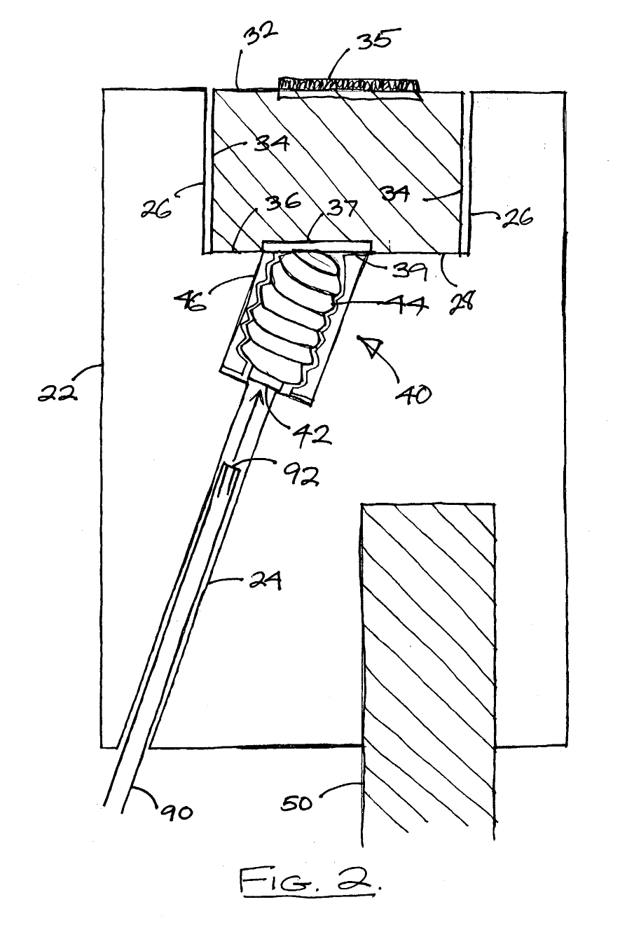

Referring now to FIG. 1, and in a preferred embodiment of the present invention, FIG. 1 is a oblique view of a typical rectangular frame 20 in a preferred embodiment of the present invention. Frame 20 is manufactured to be slidably inserted inside the existing window frame 10 of an older or historic structure, and further comprises some sort of window or screen 50. Once positioned properly, a tool 90 is inserted in apertures 24 disposed within those frame members 22 having integral splines 30. Such tool 90 may be any of a number of well known and commercially available types for turning hardware, such as a standard screwdriver, a Phillips screwdriver, a hex wrench, a TORX wrench, or a star wrench. In the most preferred embodiment of the present invention, tool 90 is of minimum diameter so that apertures 24 may be as small as practical for the admission of a sufficiently strong torque to engage the set screw in a given application.

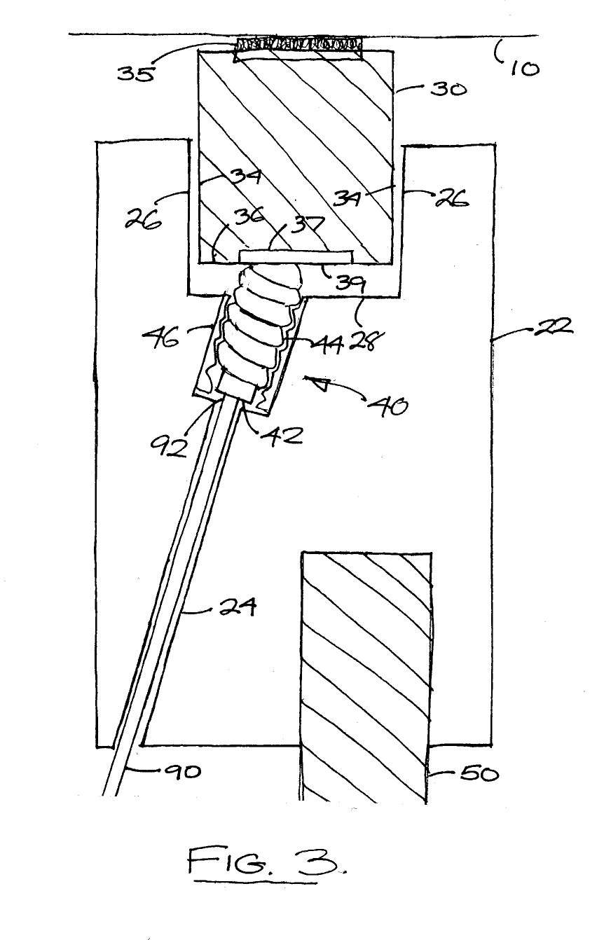

Referring now to FIG. 2, spline 30 disposed within member 22 has first opposing surface 36 against which extending hardware 40 is slidably engaged. Aperture 24 and extending hardware 40 share a common axis, and is shown at an angle relative to member 22 so that tool 90 can be conveniently inserted and turned. There is nothing in the foregoing to require these elements to be at an angle, so long as there is sufficient clearance for the facile manipulation of tool 90.

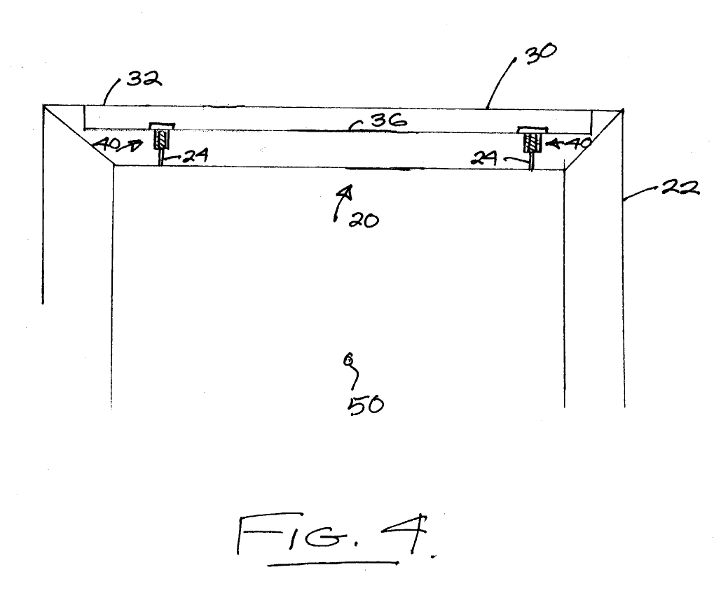

FIG. 3 is a cross section of frame portion 22 of the frame apparatus 20 of FIG. 1, showing spline member 30 in an engaged position. Distal end 92 of tool 90 engages receiving end 42 of set screw 44 to extend set screw 44 and engage spline 30 on a first opposing surface 39. First opposing surface 39 may incorporate a plate 37 which is of a material compatible with set screw 44 to prevent friction or indentation of spline 30. As set screw 44 extends it pushes spline 30 outward from frame portion 22 until it engages the window frame 10 on a second opposing surface 32. Second opposing surface 32 may incorporate a pad 35 which is of a meterial which protects the surface of window frame 10 as well as increases the friction to prevent sliding of the apparatus when it is engaged. In this engaged position, spline 30 is held within frame portion 22 by the contact of side surfaces 34 of spline 30 with side walls 26 of frame portion 22.

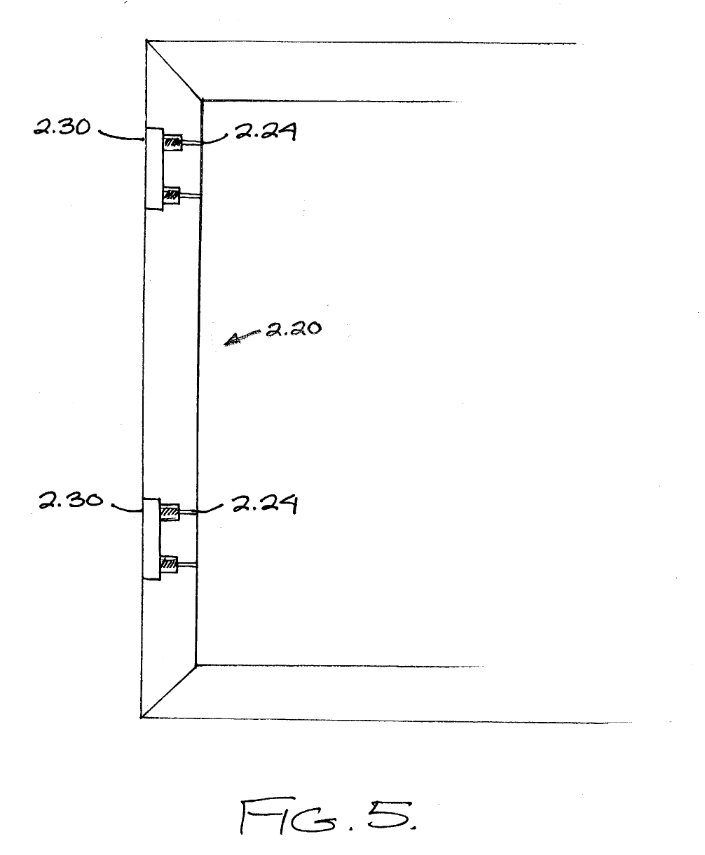

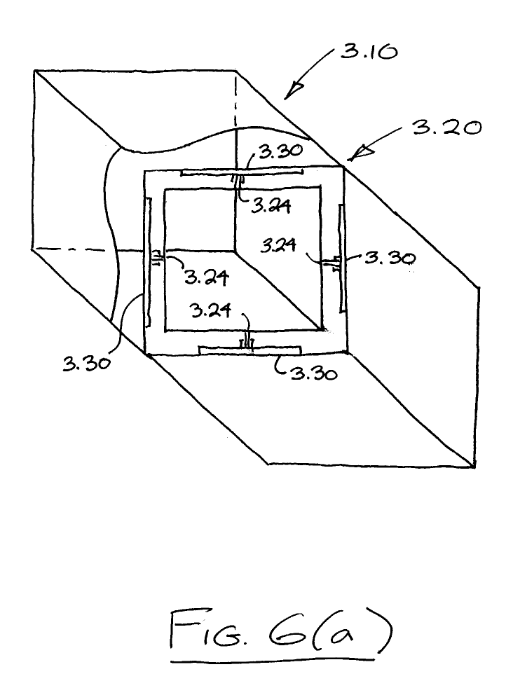

FIG. 4 is a frontal cross section of frame portion 22 of the frame apparatus 20 of FIG. 1.

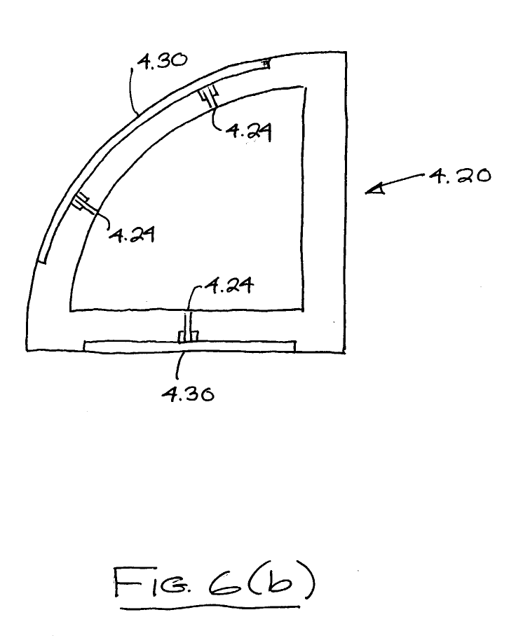

FIG. 5 is a cross section of frame portion 2.22 of the frame apparatus 2.20, according to another embodiment of the present invention, in which one or more apparatus 2.30 of the present invention are disposed within a vertically oriented member 2.22. In this manner, it becomes apparent that vertical members of a frame may incorporate the apparatus of the present invention if the application calls for it.

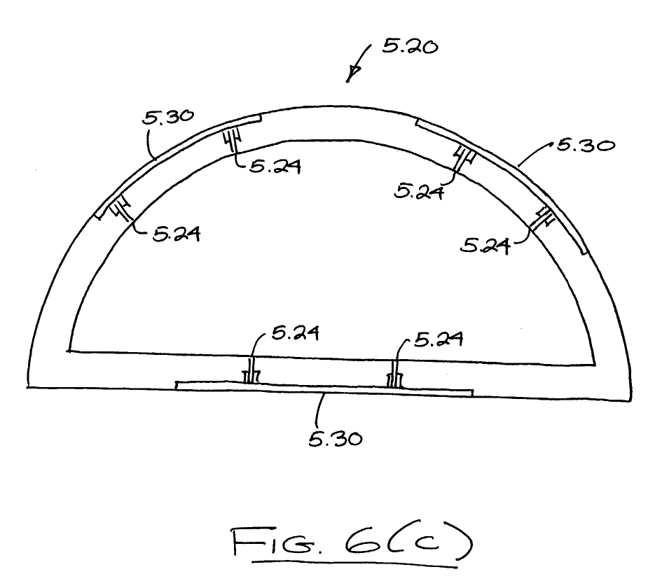

FIG. 6 is a cross section of three other embodiments of the present invention. Frame 3.20 is shown within a duct or channel 3.10 to illustrate how the present invention can be used to affix a frame of the present invention in a duct or channel 3.10. Frames 4.20 and 5.20 illustrate that the apparatus of the present invention is amenable to use in frames that are not rectangular, or any other polygram. In light of the foregoing, it is apparent to one of ordinary skill in the art of the present invention that windows of new manufacture, typically but not necessarily having a wooden frame, may incorporate frames for storm or screen windows of the type shown as 4.20 and 5.20.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein. By way of example, there is nothing in the foregoing to prevent the use of any well known and commercially available weatherstripping product around the outer surface of frame 20, so that air does not leak about the perimeter of frame 20. By way of further example, there is nothing in the foregoing to prevent the use of ultraviolet light protection in a storm window of the present invention to protect the furnishings, surfaces, and other contents inside an older or historic structure.

I claim:

1. A frame for slidable insertion into a window frame comprising:
one or more splines slidably disposed within the outer margins of said frame, said splines further comprising a first opposing surface and a second opposing surface, and
extending hardware engaging said first opposing surface,
wherein said extending hardware may be operated to extend said spline outwards to engage said second opposing surface with said window frame.
